(19) United States
(12) Patent Application Publication
(10) Pub. No.: US 2021/0341116 A1
(43) Pub. Date: Nov. 4, 2021

(54) ILLUMINATING EMERGENCY RESPONSE SYSTEM

(71) Applicant: KEVIN PATRICK MCCAUGHEY, MENIFEE, CA (US)

(72) Inventor: KEVIN PATRICK MCCAUGHEY, MENIFEE, CA (US)

(21) Appl. No.: 17/244,894

(22) Filed: Apr. 29, 2021

Related U.S. Application Data
(60) Provisional application No. 63/018,505, filed on Apr. 30, 2020.

(51) Int. Cl. F21S 9/02; F21V 23/06; F21V 23/04; F21V 21/092; F21V 23/00

(52) U.S. Cl. CPC F21S 9/022; F21V 23/06; F21Y 2115/10; F21V 21/092; F21V 23/003; F21V 23/0435

(57) ABSTRACT

An illuminating emergency response system has a components housing assembly with a distal face and a proximal face. A battery assembly and circuit board assembly are disposed within the components housing assembly. An LED light assembly and reflective housing assembly is coupled to the distal face of the components housing assembly and is coupled to the battery assembly and circuit board assembly by an electrical connector assembly. A control panel assembly with an actuator assembly is disposed on or within the proximal face of the components housing assembly. At least one radio frequency receiver and antenna assembly is designed to receive command signals originating from a remote communications device assembly. At least one suction cup assembly is coupled to the distal surface of the components housing assembly and designed to couple the components housing assembly to a window or other clear surface through which to transmit an emergency illumination signal.

### CLAIM OF PRIORITY

This application claims priority to and the benefit of U.S. Provisional Application with Ser. No. 63/018,505, filed on Apr. 30, 2020 with the same title, the contents of which are incorporated by reference in its entirety.

### FIELD OF THE INVENTION

The inventive concept relates generally to an illuminating emergency response system.

### BACKGROUND

Currently, there are a number of solutions for emergency signaling systems. One of these solutions attempts to utilize cell phones, but this solution fails to meet the needs of the market because there may not be access to a network. Another solution attempts to utilize a flare, but this solution is similarly unable to meet the needs of the market because flares cannot be used inside. Still another solution seeks to utilize a printed sign, but this solution also fails to meet market needs because printed signs may not be visible from the street or visible in the dark. Another solution is a light bulb assembly used to produce a constant light or regular flashes of light, but this solution can be difficult to position in a location that is easily externally visible. Therefore, there currently exists a need in the market for an apparatus that is easy to position and that shows first responders precisely where a person is located.

### SUMMARY OF THE INVENTION

The inventive concept is an illuminating emergency response system. A components housing assembly has a distal face and a proximal face. A battery assembly and circuit board assembly is disposed within the components housing assembly. An LED light assembly and reflective housing assembly is coupled to the distal face of the components housing assembly and is further coupled to the battery assembly and circuit board assembly by an electrical connector assembly disposed through the distal face of the components housing assembly. A control panel assembly with an actuator assembly is disposed on or within the proximal face of the components housing assembly and designed to be controllable by a user. At least one radio frequency receiver and antenna assembly designed to communicate command signals to the circuit control board assembly is designed to receive command signals originating from a remote communications device assembly. The at least one radio frequency receiver and antenna assembly may be coupled to the circuit board assembly. The command signals are designed to instruct the circuit board assembly disposed within the components housing assembly. At least one suction cup assembly is coupled to the distal surface of the components housing assembly and is designed to couple the components housing assembly to a substantially smooth and transparent surface for the LED light assembly to shine therethrough. In one embodiment, the substantially smooth and transparent surface is the window of a house or other facility.

One embodiment of the illuminated emergency response system includes a separate receiver assembly having at least one radio frequency receiver, transmitter, and antenna assembly that is designed to receive and transmit command signals originating from a remote communications device assembly. The command signals are designed to instruct the circuit board assembly disposed within the components housing assembly. In one embodiment, the signal originating from the remote communications device may pass through a plurality of radio frequency receiver, transmitter, and antenna assemblies.

A remote communication device includes but is not limited to a portable handheld device such as a smartphone assembly, a landline telephone assembly, a desktop computer assembly, or a smart speaker assembly.

In one embodiment of the illuminating emergency response system, a speaker assembly is disposed within the components housing assembly and designed to transmit at least one audio signal. The at least one audio signal may be an alarm signal designed to project sounds for emergency responses or may be a signal to the user about the operational condition of the illuminated emergency response system.

In one embodiment of the illuminating emergency response system, the LED light assembly is designed to be controllable to produce continuous light, periodic light, or light of differing intensities. Periodic light, such as a strobe, may make the LED light easier for a person or machine to detect. The light in one embodiment is blue but could be other colors. A continuous light and lights of varied intensity may allow for other benefits such as detectability, extending battery life, or allowing the inventive concept to be used as a flashlight.

LED is a light-emitting diode (LED) that is a semiconductor light source that light when and electrical current flows through it. The color of the light (corresponding to the energy of the photons) is determined by the energy required for electrons to cross the band gap of the semiconductor. White light is obtained by using multiple semiconductors or a layer of light-emitting phosphor on the semiconductor device, and in such instances, a substantially transparent outer surface may color the light from the inventive concept when the light passes therethrough.

In one embodiment of the illuminating emergency response system, a plurality of protrusions is disposed substantially perpendicularly to at least one side surface of the components housing assembly, the plurality of protrusions designed to provide a grip assembly for a user.

In one embodiment of the illuminated emergency response system, radio frequencies are received and transmitted through Bluetooth technology. Bluetooth is a wireless technology standard used for exchanging data between fixed and mobile devices over short distances using short-wavelength UHF radio waves in the industrial, scientific, and medical radio bands, and building personal area networks (PANs). RS-232 data cables may also be used in embodiments of the inventive concept. In another embodiment of the inventive concept, Wi-Fi may be used. In one embodiment, the inventive concept is a part of a larger Internet of Things (IoT) assembly.

It would be advantageous to have an inventive concept that is rechargeable and to have a rechargeable battery assembly disposed within the components housing assembly. It would be a further advantage to have an attachment assembly on which could be displayed a logo or other words or icons.

The inventive concept advantageously fills the aforementioned deficiencies by providing an emergency response system, which provides a way for someone to locate a person who needs help.

The inventive concept fulfills the need for a mountable emergency light.

Among other things, it is an advantage of the inventive concept to provide an emergency response system that does not suffer from problems or deficiencies associated with prior solutions.

It is still further an advantage of the inventive concept to be activated when 911 or international equivalents are called.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the back side view of the inventive concept.

FIG. 2 illustrates the front side view of the inventive concept.

FIG. 3 illustrates the top side view of the inventive concept.

FIG. 4 illustrates the right side view of the inventive concept.

FIG. 5 illustrates the left side view of the inventive concept.

FIG. 6 illustrates the back side perspective view of the inventive concept.

FIG. 7 illustrates the front side perspective view of the inventive concept.

FIG. 8 illustrates the expanded view of the inventive concept.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

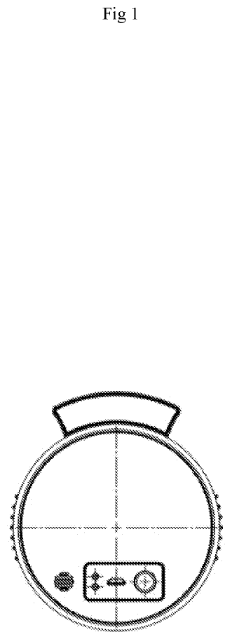

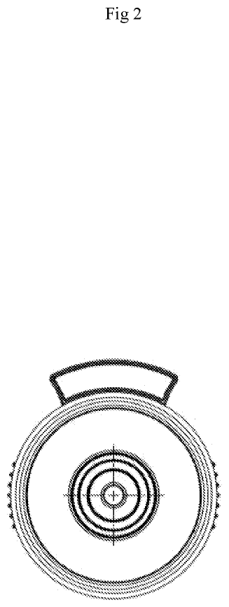

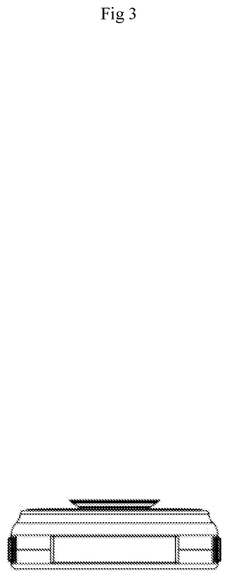

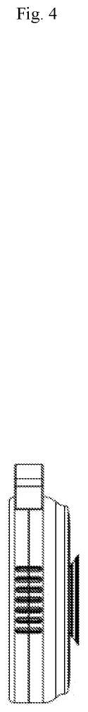

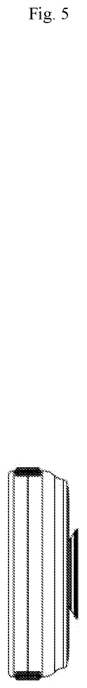

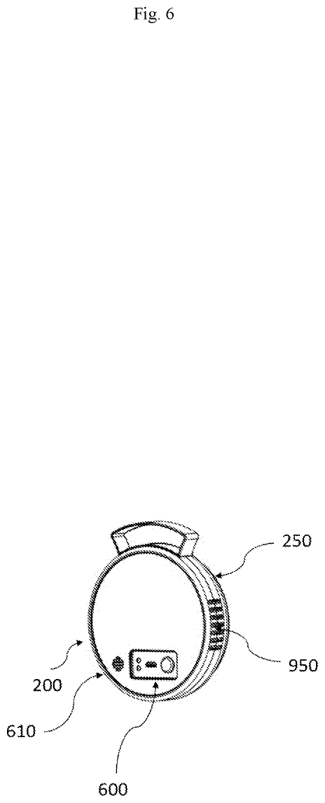

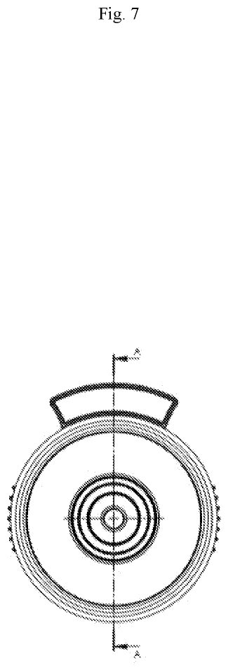

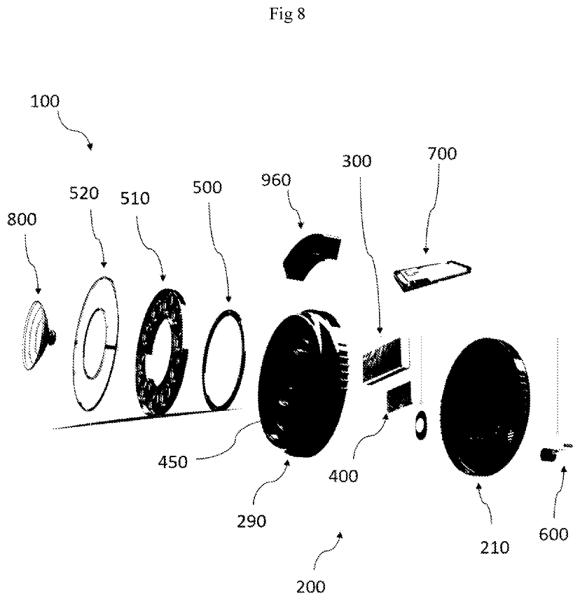

Referring to the figures and the Appendix, FIG. 1-8 illustrates an illuminating emergency response system 100. A components housing assembly 200 has a distal face 290 and a proximal face 210. A battery assembly 300 and circuit board assembly 400 is disposed within the components housing assembly 200. An LED light assembly 500 and reflective housing assembly 510 is coupled to the distal face 290 of the components housing assembly 200 and is further coupled to the battery assembly 300 and circuit board assembly 400 by an electrical connector assembly 450 disposed through the distal face 290 of the components housing assembly 200. A substantially clear plastic cover assembly 520 covers the reflective housing assembly 510. A control panel assembly 600 with an actuator assembly 610 is disposed on or within the proximal face 210 of the components housing assembly 200 and designed to be controllable by a user. At least one radio frequency receiver and antenna assembly 700 designed to communicate command signals to the circuit control board assembly 400 is designed to receive command signals originating from a remote communications device assembly. The at least one radio frequency receiver and antenna assembly 700 is coupled to the circuit board assembly 400. The command signals are designed to instruct the circuit board assembly 400 disposed within the components housing assembly 200. At least one suction cup assembly 800 is coupled to the distal face 290 of the components housing assembly 200 and designed to couple the components housing assembly 200 to a substantially smooth and transparent surface for the LED light assembly 500 to shine therethrough. A speaker assembly 900 is disposed within the components housing assembly 200. A plurality of protrusions 950 is disposed substantially perpendicularly to at least one side surface 250 of the components housing assembly 200. An attachment assembly 960 can display a logo or other words or icons.

Various related embodiments of the inventive concept are also described in Appendix A, which is incorporated herein by reference in its entirety. The following patents are incorporated by reference in their entireties: U.S. Pat. Nos. 6,556,148, 7,940,166, 10,154,401, and 9,300,799.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An illuminating emergency response system comprising:
a components housing assembly with a distal face and a proximal face;
a battery assembly electrically coupled to a circuit board assembly including a processor, the battery assembly and circuit board assembly disposed within the components housing assembly;
an LED light assembly and reflective housing assembly coupled to the distal face of the components housing assembly and further coupled to the battery assembly and circuit board assembly by an electrical connector assembly disposed through the distal face of the components housing assembly;
a control panel assembly with an actuator assembly disposed on or within the proximal face of the components housing assembly and adapted to be controllable by a user;
at least one radio frequency receiver and antenna assembly adapted to communicate command signals to the circuit control board assembly and adapted to receive command signals originating from a remote communications device assembly, the command signals adapted to instruct the processor of the circuit board assembly disposed within the components housing assembly; and
at least one suction cup assembly coupled to the distal surface of the components housing assembly and adapted to couple the components housing assembly to a substantially smooth and transparent surface for the LED light assembly to shine therethrough.

2. The illuminated emergency response system of claim 1 wherein a separate receiver assembly including at least one radio frequency receiver, transmitter, and antenna assembly is adapted to receive and transmit command signals originating from a remote communications device assembly, the command signals adapted to instruct the processor of the circuit board assembly disposed within the components housing assembly.

3. The illuminating emergency response system of claim 1 wherein a speaker assembly is disposed within the components housing assembly and includes a processor adapted to transmit at least one audio signal.

4. The illuminating emergency response system of claim 1 wherein the LED light assembly includes a processor adapted to be controllable to produce continuous light, periodic light, or light of differing intensities.

5. The illuminating emergency response system of claim 1 wherein a plurality of protrusions is disposed substantially perpendicularly to at least one side surface of the components housing assembly, the plurality of protrusions adapted to provide a grip assembly for a user.
